(19) United States
(12) Patent Application Publication
(10) Pub. No.: US 2013/0139436 A1
(43) Pub. Date: Jun. 6, 2013

(54) Protective Sleeve for Tubular Conduits Used in Sap Collection.

(71) Applicant: Gregory R. Pripps, Butternut, WI (US)

(72) Inventor: Gregory R. Pripps, Butternut, WI (US)

(21) Appl. No.: 13/693,030

(22) Filed: Dec. 3, 2012

Related U.S. Application Data
(60) Provisional application No. 61/565,722, filed on Dec. 1, 2011.

(51) Int. Cl. A01G 13/10

(52) U.S. Cl. CPC A01G 13/10
USPC 47/52; 47/58.1 R

(57) ABSTRACT

A protective sleeve for plastic tubing used in the collection of sap. The sleeve provides protection from damage or interference by varmints.

### FIELD OF THE INVENTION

The present invention relates to protecting tubular conduit members of a tree sap collecting system wherein the trees are attached to tubular conduit leading to a vacuum pump house or station. In particular toward a method for protecting such conduit from a breach of the seal damage and interference from varmints.

### BACKGROUND OF THE INVENTION

Sap collected from trees, typically maple but can include other species such as birch, is concentrated and used for its valued sugar content. In times past the sap was collected from a tap point via buckets attached to a spigot implanted into the trunk of the tree. In these times, the sap is collected from the tap point via vacuum compatible tubing such as polyethylene at about 5/16 inch in diameter.

The tubing as currently utilized is prone to attack from varmints which can include; squirrels, mice, rats, opossums, raccoons and the like. Such varmints are attracted to the smell of the sweet sugars, typically near the tap point, and gnaw or chew on the tubing until they can reach the sap. The most common chew point being within 16″ of the tree on the lateral lines or anywhere along the drop lines from the tap point to the lateral line. Lateral lines of the lines that run from tree to tree or to the pump house. Drops are the tubing that runs from the lateral line to the tap point also referred to as spout or plug which extends into the hole in the tree. This causes the obvious problem of damage to equipment and diminished yield, but also introduces aseptic conditions into the system.

Since the beginning of the use of plastic tubing for the extraction and collection of maple sap, these varmints have been chewing on the tubing causing extra work and monetary costs from the loss of sap and labor and materials to replace tubing that has been damaged. Each chew hole makes the vacuum less effective. This is especially pronounced in high vacuum applications.

The prior art does contain a metallic coil wrap, similar to a spring, which is wrapped around the outer shell of the tubing. The spring supplies structural support as well as some small deterrent to varmints. However, such a system allows gaps when the tubing is flexed which can allow for attack points. Further it is relatively heavy and expensive, relying upon a sufficient thickness of spring material that the varmint would not be able to chew through it. Much of the coil does not spring back into position, which creates problems with reusability.

For the system to be protective, it is anticipated that not all tubing needs to be protected. For example at many places along the main conduit back to the pump house as mentioned above, the varmints do not seem to be attracted, probably due to the lack of sweet olfactory stimuli. It is also anticipate that while the whole of the tubing could be sleeved, it may not be necessary and would save costs to be expeditious in where the sleeve is placed.

### SUMMARY OF THE INVENTION

In accordance with the present invention, there is provided a sleeve comprising stainless steel braiding to envelop the tubing over strategic portions of the tubing. It is anticipated that the braiding be formed from strands having a range of 0.004 to 0.012 inch. Quarter hard to full hard wire between the diameters of 0.006 to 0.008 inch is preferred. The sleeve can either be constructed by means of braiding or knitting the stainless steel strands together to form the sleeve. Single or multiple end wires could be used, with single end wires being preferred. Other types of wire such as galvanized, hard aluminum, alloy, copper, brass or an Aramid fiber such as Kevlar can also be used. Whatever the specifics, this knitted sleeve eliminates large voids or gaps found in the prior art spring which allows teeth to access the tubing unabated.

While the sleeve can be formed into the tubing as one integrated unit, it is preferred that the sleeve fit loosely about the tubing for several reasons. A loose sleeve moves somewhat which does not provide a good lever point for the varmint's teeth. This serves to deter a large number of potential breeches of the system. Additionally the sleeves can be situated in a pillowed arrangement with a fastener such as a zip tie or pinch clamp, which seeks to offset the sleeve from the tubing creating an air space in between. This will make the tubing less desirable for the varmints to continue chewing as all they will bite is metal. Further, having the sleeve separate from the tubing will cause much of the energy imparted by the varmint into simply moving the sleeve back and forth.

If and when a varmint does chew through or break a wire or wires in the sleeve, the broken wire results in strands which are small and sharp. These broken strands will prick the soft tissues of the mouth region; such as lips, gums, and soft palate of the varmint giving a very unpleasant sensation, such as chewing on a piece of barbed wire. This serves to deter the varmint animal from continuing such behavior. Yet, a few small strands which may be broken do not overly irritate the human hand, and remains substantially smooth to the touch.

With a typical 5/16 inch tubing it is anticipated that the sleeve could range between approximately 1/2″ to 3/4″ in diameter in a typical application and be stretched. It can also be fastened by any suitable means, such as zip ties for example.

It is therefore an object of the invention to provide a sleeve typically comprised of a stainless steel to envelop the tubing.

It is therefore an object of the invention to allow the sleeve to fit loosely about the tubing.

It is another object of the invention that this sleeve to provide be applied discriminately to the tubing, ie. In selected areas only as the user prefers.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of two trees being tapped for sap;

FIG. 2 is a perspective view of a section of tubing with a sleeve and a frayed end to further inhibit chewing at an end section.

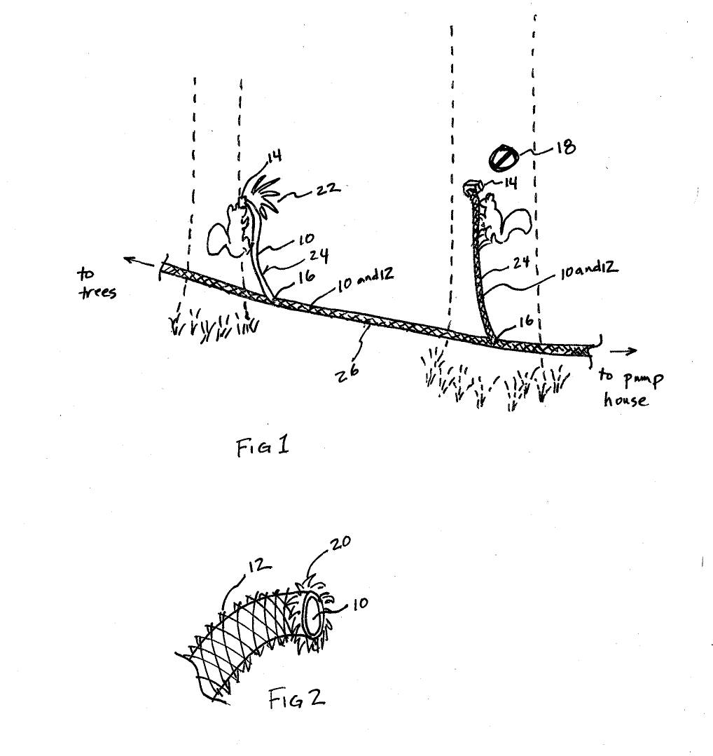

### DETAILED DESCRIPTION

Tubing (10) and a sleeve (12) running on lateral lines (26) between a series of trees and a pump house and connected at a splice point (16) to a plurality of drop lines (22) comprising in one instance a tubing (10) with a sleeve (12) and in another instance a tubing (10) only are depicted. Each drop line (22) terminates at a tap point (14). In one instance (left) a varmint has chewed through the tubing (10) only and created a compromise to the system (22) such as a leak. In one instance (right) a varmint has encountered a tubing (10) having a sleeve (12) and is not able to chew through the line as indicated by the “not” sign (18).

FIG. 2 demonstrates a tubing (10) having a sleeve (12) and further comprising a fray (20) near the termination point. Such a fray (20) further inhibits chewing behavior.

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

For example,

Having thus described the invention, what is desired to be protected by Letters Patent is presented in the subsequent appended claims.

We claim:

1. A method for protecting a section of tubing used in the collection of tree sap from a varmint comprising; combining a sleeve with the section of tubing such that when chewed by a varmint, the sleeve creates an undesirable sensation which inhibits the varmint from continuing to chew.

2. The method of protecting a section of tubing used in the collection of tree sap from a varmint in accordance with claim 1 wherein the undesirable sensation includes pricking the varmint's mouth region.

3. The method of protecting a section of tubing used in the collection of tree sap from a varmint in accordance with claim 2 wherein the sleeve does not overly irritate the human hand to the touch.

4. The method of protecting a section of tubing used in the collection of tree sap from a varmint in accordance with claim 3 wherein the sleeve comprises strands of at least one of stainless steel, galvanized steel, hard aluminum, alloyed metal, brass, or Aramid fibers.

5. The method of protecting a section of tubing used in the collection of tree sap from a varmint in accordance with claim 4 further comprising barbs being incorporated into the sleeve.

6. The method of protecting a section of tubing used in the collection of tree sap from a varmint in accordance with claim 4 wherein the sleeve comprises a braiding or a mesh formed of stainless steel wire being between 0.004 and 0.012 inches in diameter.

7. The method of protecting a section of tubing used in the collection of tree sap from a varmint in accordance with claim 4 wherein the sleeve comprises braiding formed of a quarter to full hard stainless steel wiring being between 0.006 and 0.008 inches in diameter.

8. The method of protecting a section of tubing used in the collection of tree sap from a varmint in accordance with claim 4 wherein the sleeve is approximately 1/16 to ¼ inch larger than the tubing.

9. The method of protecting a section of tubing used in the collection of tree sap from a varmint in accordance with claim 8 wherein the sleeve is fit loosely about the tubing.

10. The method of protecting a section of tubing used in the collection of tree sap from a varmint in accordance with claim 9 is combined with the vertical section of tubing near the tap point of the tubing into the tree using at least one of zip ties of pinch clamps.

11. The method of protecting a section of tubing used in the collection of tree sap from a varmint in accordance with claim 9 wherein the sleeve extends approximately twelve to sixteen inches from the tap point of the tubing into the tree.

12. A system for protecting a section of tubing used in the collection of tree sap from a varmint comprising; combining a sleeve with the section of tubing such that when chewed by a varmint, the sleeve creates an undesirable sensation which inhibits the varmint from continuing to chew.

13. The system for protecting a section of tubing according to claim 12 wherein the undesirable sensation is a pricking of the varmints mouth.

14. The system for protecting a section of tubing according to claim 12 wherein the sleeve does not overly irritate the human hand to the touch.

15. The system for protecting a section of tubing according to claim 12 wherein the sleeve comprises strands of at least one of stainless steel, galvanized steel, hard aluminum, alloyed metal, brass, or Aramid fibers.

16. The system for protecting a section of tubing according to claim 15 wherein the sleeve comprises a braiding or a mesh formed of stainless steel wire being between 0.004 and 0.012 inches in diameter.

17. The system for protecting a section of tubing according to claim 12 wherein the sleeve is fit loosely about the tubing.

18. The system for protecting a section of tubing according to claim 12 wherein the sleeve does not cover the entire length of the tube.

19. The system for protecting a section of tubing according to claim 18 wherein the sleeve is shorter in length then the tube.
